(19) United States
(12) Patent Application Publication
(10) Pub. No.: US 2017/0084229 A1
(43) Pub. Date: Mar. 23, 2017

(54) HIGH RESOLUTION OLED DISPLAY OPERATION CIRCUIT

(71) Applicant: COMMONWEALTH SCIENTIFIC AND INDUSTRIAL RESEARCH ORGANISATION, Acton, ACT (AU)

(72) Inventors: Tadahiko Hirai, Mount Waverly, Victoria (AU); Kazunori Ueno, Glen Waverly, Victoria (AU)

(73) Assignee: COMMONWEALTH SCIENTIFIC AND INDUSTRIAL RESEARCH ORGANISATION, Acton (AU)

(21) Appl. No.: 15/312,377

(22) PCT Filed: May 19, 2015
(86) PCT No.: PCT/AU2015/000295

§ 371 Date: Nov. 18, 2016

(30) Foreign Application Priority Data
May 19, 2014 (AU) 2014901852

(51) Int. Cl. G09G 3/3283; G09G 5/10

(52) U.S. Cl. CPC G09G 3/3283; G09G 5/10; G09G 2300/043; G09G 2300/0819; G09G 2300/0842

(57) ABSTRACT

A light-emitting display panel sub-pixel circuit, comprising: at least three switches; at least one capacitive element; at least one light-emitting element; a power line serving as a wire for connecting the at least three switches, the at least one capacitive element, and the at least one light-emitting element; an earth line; a scan line for selecting a sub-pixel for light emission; a data line for supplying data to the light-emitting element; and a sense line for detecting degradation of the light-emitting element, wherein the data corresponding to a predetermined luminous intensity are programmed on the basis of a voltage.

### TECHNICAL FIELD

The present invention relates to a light-emitting display panel sub-pixel circuit employing an organic electro-luminescence element such as organic light-emitting diode (OLED) or organic EL, a drive method therefore, and a display panel/unit using the sub-pixel circuit.

### BACKGROUND ART

Display panels using a two-terminal display device that emits light at luminous intensity corresponding to a direct current level, such as an organic electroluminescence element or organic light-emitting diode (OLED); namely, devices employing organic electro luminescence (EL), have recently been developed.

Implementation of a high-luminance, high-contrast image display requires an active drive through the use of a switching element or, for example, a thin film transistor (TFT). Typically, the OLED is a light-emitting device that has a laminated structure of a thin organic material and varies emission intensity according to the level of an electric current. A display unit that displays an image can be configured by using TFTs to pass an electric current through an OLED provided on each of pixels or sub-pixels disposed on a matrix and thereby allow the pixel or sub-pixel to emit light.

In active matrix drive OLEDs, many light-emitting regions called pixels are typically arranged in a matrix form, where their lines are scanned one by one for repeated writing (programming) operation for luminescence or colour tone. One pixel is typically composed of a plurality of sub-pixels having different colour tones, in which the luminescence and colour tone of the pixel is controlled through the control of a combination of luminescence for each sub-pixel.

A sub-pixel is connected to a plurality of matrix wires and is composed of a plurality of switching elements, light-emitting elements, and capacitive elements (capacitors). Various drive methods have been proposed to correct the variation in characteristics of the switching elements and light-emitting elements as well as changes in characteristics caused by the degradation.

FIG. 1 is a diagram showing an exemplary configuration of a current program method in a sub-pixel circuit using an OLED and its drive method. FIG. 1(a) is a diagram showing an example application of a current mirror circuit array to a sub-pixel circuit array (see, for example, PTL 1), in which a mirror transistor forming part of current mirror circuits 11 to 17 is programmed to cause a predetermined level of current to flow therethrough so as to cause a current proportional to it to flow through an OLED forming part of sub-pixel circuits 19 to 25. FIG. 1(b) is a diagram of a current mirror circuit 31 and a sub-pixel circuit 33 in which data (current) to be programmed is passed through the OLED and the current itself flowing through the OLED is thereby programmed (see, for example, Non Patent Literature NPL 1). The drive method of this circuit by current programming tends to result in an increase in the number of switching elements per sub-pixel, although it has an advantage of providing precise control of an electric current flowing through the OLED. Also, the method is not adequate for implementing a high-definition display having a small pixel area and high-speed scanning, since current programming is time consuming.

FIG. 2 is a diagram showing an exemplary configuration of a voltage program method in a sub-pixel circuit using an OLED and its drive method. FIG. 2(a) is a diagram showing an example of a drive circuit 35 which includes a threshold correction circuit which applies a threshold correction function for a switching element (see, for example, PTL 2). FIG. 2(b) is a diagram showing an example of a voltage control circuit 39 mitigating degradation of an OLED through the release and resetting of a voltage applied to an OLED (see, for example, PTL 3). The voltage program method applied by the voltage control circuit 39 has an advantage of implementing high-speed scanning as well as reducing the number of switching elements per pixel. In contrast, the voltage program method has difficulty in correcting switching element threshold variation and OLED degradation simultaneously.

There has recently been increasing demand for higher definition and higher-speed scanning. In order to satisfy this demand, it would be desirable to provide display units that employ various means and their drive methods should be offered.

OLED display units designed for use in mobile devices which have recently been gaining attention require high definition ranging from 300 ppi (pixel per inch) up to 400 ppi. A high-definition OLED display unit of 400 ppi, for example, has one pixel of 60 micron square size. Also, 60 frames/sec or higher speed scanning is required in order to implement smoother motion picture display, making it very difficult to reduce the number of switching elements per pixel and at the same time provide an effective correction. There is a currently known technology for incorporating a threshold variation correction for switching elements into a voltage program drive method, but the technology is not sufficiently satisfactory to ensure variation correction and long-term reliability.

It would be desirable to provide a light-emitting display panel sub-pixel circuit, its drive method, and a display panel/unit using the sub-pixel circuit and its drive method.

### SUMMARY

One aspect of the invention provides a light-emitting display panel sub-pixel circuit according to one embodiment of the present invention including at least three switches, at least one capacitive element, at least one light-emitting element, a power line connecting the at least three switches, the at least one capacitive element and the at least one light-emitting element, an earth line, a scan line for selecting a sub-pixel for light emission, a data line for supplying data to the light-emitting element, and a sense line for detecting degradation of the light-emitting element, wherein the data corresponding to a predetermined luminous intensity are programmed on the basis of a voltage.

Another aspect of the invention provides a sub-pixel drive method for a light-emitting display panel wherein, in the light-emitting display panel sub-pixel circuit, the sense line is pre-charged at a predetermined pre-charge voltage, and a voltage variation of the sense line is detected at the time of the activation of the sense transistor associated with the selection of a sub-pixel.

Another aspect of the invention provides a display panel wherein a plurality of sub-pixels including a sub-pixel circuit for the light-emitting display panel is disposed in a matrix.

Another aspect of the invention provides a display unit including a display panel.

One or more embodiments of the invention can implement a sub-pixel circuit, its drive method, and a display panel/unit using such a sub-pixel circuit and its drive method, which is high-definition and capable of high-speed scanning and correcting variation in switching transistor characteristics as well as light-emitting element (OLED) degradation.

### BRIEF DESCRIPTION OF DRAWINGS

FIG. 1 is a diagram showing an example configuration of a current program method in a sub-pixel circuit using a conventional OLED and its drive method. FIG. 1(a) is a diagram showing an example application of a current mirror circuit array to a sub-pixel circuit array. FIG. 1(b) is a diagram of a current mirror circuit and a sub-pixel circuit in which data (current) to be programmed is passed through the OLED and the current itself flowing through the OLED is thereby programmed.

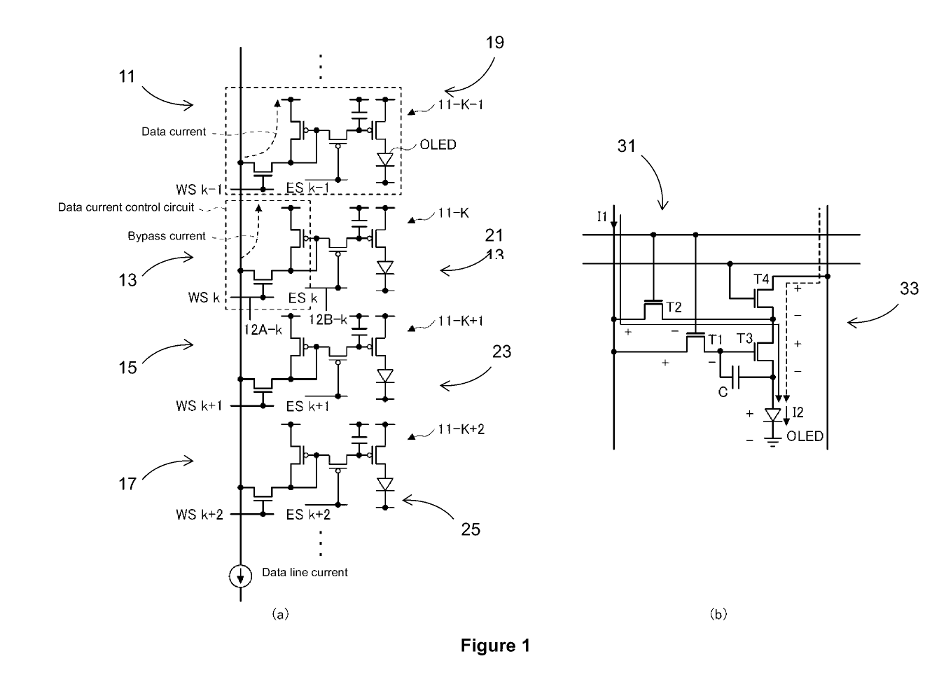

FIG. 2 is a diagram showing an exemplary configuration of a voltage program method in a sub-pixel circuit using a conventional OLED and its drive method. FIG. 2(a) is a diagram showing an example of a drive circuit which includes a threshold correction circuit which applies a threshold correction function for a switching element. FIG. 2(b) is a diagram showing an example of voltage control circuit mitigating OLED degradation.

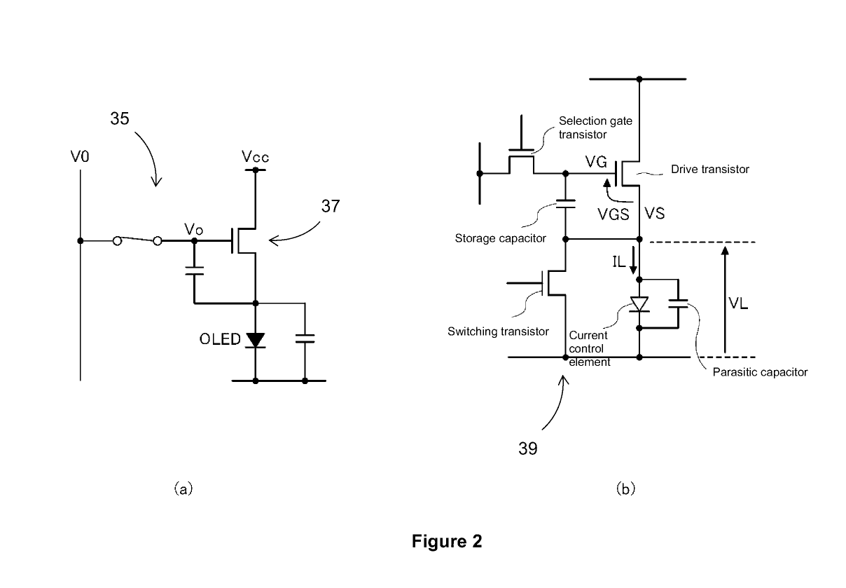

FIG. 3 is a diagram showing an example configuration of a sub-pixel circuit using an OLED including a compensating circuit according to an embodiment of the present invention. FIG. 3(a) is a diagram showing a first example configuration of a sub-pixel circuit. FIG. 3(b) is a diagram showing a second example configuration of a sub-pixel circuit. FIG. 3(c) is a diagram showing a third example configuration of a sub-pixel circuit. FIG. 3(d) is a diagram showing a fourth example configuration of a sub-pixel circuit.

FIG. 4 is a schematic diagram showing an example of signal waveforms of a sub-pixel circuit using an OLED.

FIG. 5 is a diagram showing an example configuration of a sub-pixel circuit using an OLED including a compensating circuit according to an embodiment of the present invention. FIG. 5(a) is a diagram showing a first example configuration of a sub-pixel circuit. FIG. 5(b) is a diagram showing a second example configuration of a sub-pixel circuit.

FIG. 6 is a schematic diagram showing an example of signal waveforms of a sub-pixel circuit using an OLED.

FIG. 7 is a diagram of an example of a sub-pixel circuit configuration using an OLED, which shows operation of a compensating circuit.

FIG. 8 is a diagram of an example of a sub-pixel circuit configuration using an OLED, which shows operation of a compensating circuit.

FIG. 9 is a graph showing OLED degradation characteristics.

FIG. 10 is an example of a look-up table and a mathematical model used in compensation operation. FIG. 10(a) is a look-up table showing OLED characteristics. FIG. 10(b) is a look-up table showing drive TFT characteristics and a mathematical model.

### DETAILED DESCRIPTION OF THE DRAWINGS

Embodiments according to the present invention will be described below with reference to the attached drawings. Through the drawings, reference numbers are re-used to indicate correspondence between referenced embodiments.

### First Embodiment

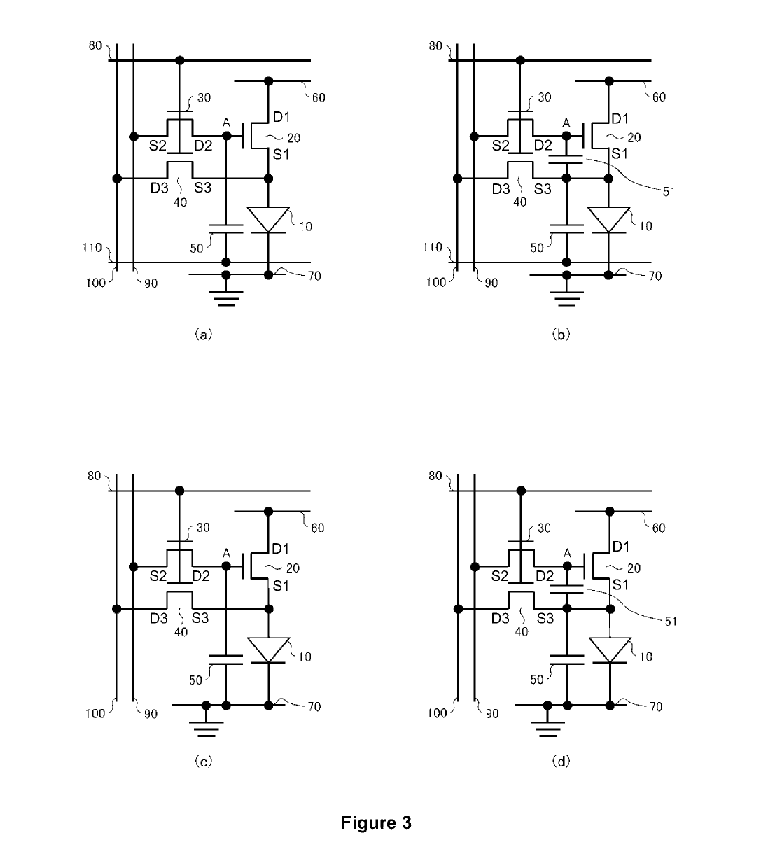

FIG. 3 is a diagram showing a sub-pixel circuit of a light-emitting display unit according to a first embodiment of the present invention. In the first embodiment, one sub-pixel is composed of three n-channel TFTs 20, 30, 40, one or two capacitive elements (capacitors) 50, and one OLED 10, which are connected to a scan line 80, a data line 90, a power line 60, a correction line 110, and an earth line 70.

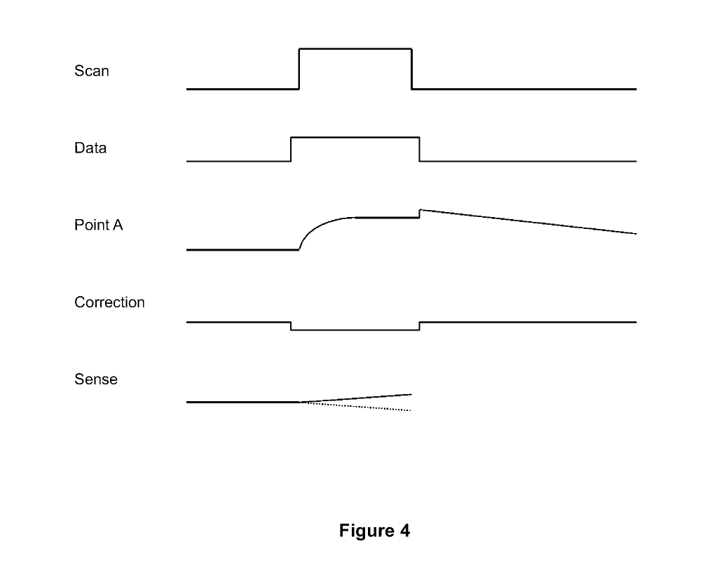

FIG. 4 is a schematic diagram showing a voltage application in a sub-pixel circuit of FIG. 3 as time passes. “Point A” of FIG. 4 corresponds to point A in a wire connected to a gate of the drive TFT 20 of FIG. 3, showing a gate voltage of the drive TFT 20 as time passes.

In FIG. 3(a), a drain D1 of a drive TFT 20 is connected to the power line 60, and a source S1 is connected to an anode of the OLED 10. A cathode of the OLED 10 is connected to the earth line 70. A gate of the drive TFT 20 is connected to one electrode of the capacitive element 50 and a drain D2 of the selection TFT 30. A gate of the selection TFT 30 is connected to the scan line 80 and the source S2 is connected to the data line 90. Meanwhile, the other electrode of the capacitive element is connected to the correction line 110. A gate of the sense TFT 40 is connected to the scan line 80, and a drain D3 is connected to the sense line 100, and a source S3 is connected to an anode of the OLED 10.

The OLED 10 is a light-emitting element that emits light with luminescence corresponding to a voltage applied across the anode and the cathode, or a current flowing across the anode and the cathode. The drive TFT 20 is a transistor for driving the OLED 10 for light emission. The selection TFT 21 is a transistor for selecting a sub-pixel to be driven for light emission. The sense TFT 40 is a transistor for detecting the degradation of the OLED 10.

The power line 60 is a wire provided for supplying electric power to a sub-pixel circuit. The earth line 70 is a wire for grounding circuit elements contained in the sub-pixel circuit. The scan line 80 is a wire for selecting a sub-pixel. Supplying the scan line 80 with a selection voltage that activates the selection TFT 30 allows the selection of a sub-pixel to be driven for light emission. The data line 90 is a wire for supplying data (voltage) to the OLED 10. The luminescence of the OLED 10 is controlled by the level of this voltage. The sense line 100 is a wire for detecting voltage variation caused by degradation in the OLED 10 and, in cooperation with the sense TFT 40, detects variation in anode voltage of the OLED 10. The correction line 110 is a wire for correcting (compensating) voltage variation to cause the OLED 10 to emit with the same luminescence under variation of the anode voltage of the OLED 10 required for light emission with a predetermined luminescence.

When a voltage is applied to the scan line 80 and to the gate of the selection TFT 30, the selection TFT 30 becomes activated, causing a data signal (voltage) applied to the data line 90 to be applied to the gate (point A) of the drive TFT 20. This results in a predetermined level of current flowing to the OLED 10, causing the OLED 10 to emit light with luminescence corresponding to the data signal (voltage). When no voltage is present in the scan line 80, the selection TFT 30 becomes deactivated, but the gate voltage (point A) of the drive TFT 20 is maintained at a constant level by the capacitive element 50 until a scan voltage is applied again.

A voltage of the sense line 100 is pre-charged at a level corresponding to an anode voltage that occurs when a predetermined level of current flows through the OLED 10. When a voltage is applied to the scan line 80 and to the gate of the selection TFT 30 and the sense TFT 40, a voltage is applied to a gate of the drive TFT 20, causing a predetermined level of current corresponding to the data signal (voltage) to begin to flow through the OLED 10. At this time, the sense TFT 40 is in the activated state, resulting in a comparison between anode voltage of the OLED 10 and voltage of the pre-charged sense line 100. If the anode voltage is higher than the voltage of the sense line 100, a current flows into the sense line 100. If lower, a current flows out of the sense line 100. A determination as to which one of these two states occurs will be made by the detection of a voltage variation in the sense line 100.

In FIG. 3(b), the drain D1 of the drive TFT 20 is connected to the power line 60, and the source S1 is connected to an anode of the OLED 10. A cathode of the OLED 10 is connected to the earth line 70. A gate of the drive TFT 20 is connected to one electrode of a capacitive element 51 and the drain D2 of the selection TFT 30. A gate of the selection TFT 30 is connected to the scan line 80, and the source S2 is connected to the data line 90. The other electrode of the capacitive element 51 is connected to an anode of the OLED 10. Meanwhile, one electrode of the capacitive element 50 is connected to the anode of the OLED 10, and the other electrode is connected to the correction line 110. A gate of the sense TFT 40 is connected to the scan line 80, and a drain D3 is connected to the sense line 100, and a source S3 is connected to the anode of the OLED 10.

When a voltage is applied to the scan line 80 and to the gate of the selection TFT 30, the selection TFT 30 becomes activated, causing a data signal (voltage) applied to the data line 90 to be applied to the gate (point A) of the drive TFT 20. This results in a predetermined level of current flowing to the OLED 10, causing the OLED 10 to emit light with luminescence corresponding to the data signal (voltage). When no voltage is present in the scan line 80, the selection TFT 30 becomes deactivated, but the gate voltage (point A) of the drive TFT 20 is maintained at a constant level by the capacitive elements 50, 51 until a scan voltage is applied again. The difference from the second embodiment of FIG. 3(a) lies in the use of the two capacitive elements 50, 51 connected in series. In other words, the difference is that, when a predetermined level of current begins to flow through the OLED 10, a voltage is applied to the anode of the OLED 10, which causes the capacitive element 51 to act to maintain a voltage between the gate and source (anode of the OLED) of the drive TFT, thereby automatically correcting a variation in threshold of the drive TFT 20.

As is the case with the embodiment of FIG. 3(a), the voltage of the sense line 100 is pre-charged at a level corresponding to an anode voltage that occurs when a predetermined level of current flows through the OLED 10. When a voltage is applied to the scan line 80 and to the gate of the selection TFT 30 and the sense TFT 40, a voltage is applied to a gate of the drive TFT 20, causing a predetermined level of current corresponding to the data signal (voltage) to begin to flow through the OLED 10. At this time, the sense TFT 20 is in the activated state, resulting in a comparison between anode voltage of the OLED 10 and voltage of the pre-charged sense line 100. If the anode voltage is higher than the voltage of the sense line 100, a current flows into the sense line 100. If lower, a current flows out of the sense line 100. A determination as to which one of these two states occurs will be made by the detection of a voltage variation in the sense line 100.

Degradation in emission intensity of the OLED 10 caused by its deterioration usually results in increased resistance, which tends to cause a voltage required for passing a predetermined level of current through the OLED 10 to become high. For this reason, the OLED 10, if deteriorated, tends to cause the anode voltage of the OLED 100 to become higher than the pre-charge voltage of the sense line 100. If this occurs, a desired level of emission intensity cannot be obtained even if a predetermined level of current is passed through the OLED 10 (namely, degradation in emission intensity).

FIGS. 3(a) and (b) show means for correcting degradation in emission intensity by applying a correction voltage to the correction line 110. As shown in FIG. 4, application of the correction voltage following the completion of the scan voltage application increases the gate voltage (point A) of the drive TFT 20 by a degree of the correction voltage, which causes a level of current flowing through the OLED 10 to be increased or reduced by a degree corresponding to the correction voltage. The correction voltage is set according to the degree of deterioration of the OLED 10, thereby allowing a predetermined level of emission intensity to be maintained despite the deterioration of the OLED 10.

Meanwhile, FIGS. 3(c) and (d) show that adding the correction voltage to a voltage applied to the gate (point A) of the drive TFT 20 increases or reduces a level of current flowing through the OLED 10 by a degree corresponding to the correction voltage.

### Second Embodiment

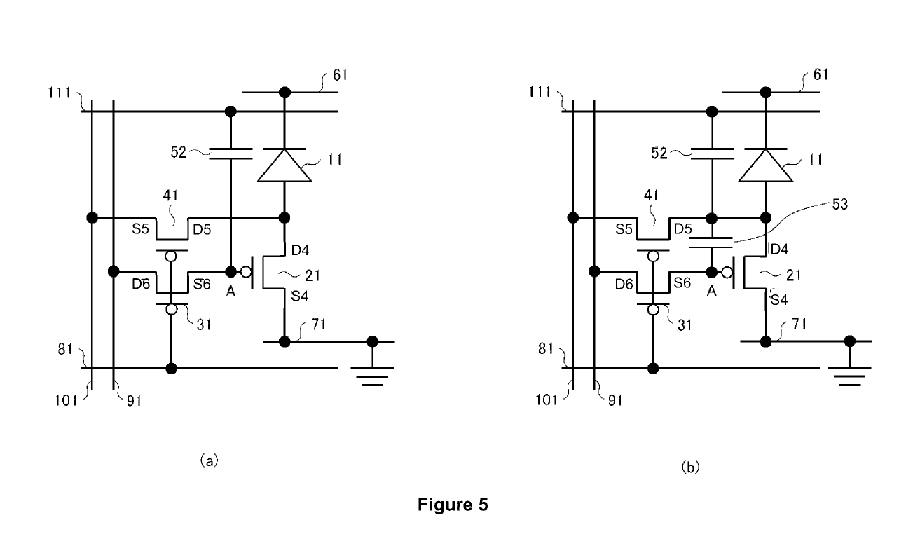

FIG. 5 is a diagram showing a sub-pixel circuit of a light-emitting display unit according to a second embodiment of the present invention. In the second embodiment, one sub-pixel is composed of three p-channel TFTs 21, 31, 42, one or two capacitive elements (capacitors) 51, 52, and one OLED 11, which are connected to a scan line 81, a data line 91, a power line 61, a correction line 111, and an earth line 71.

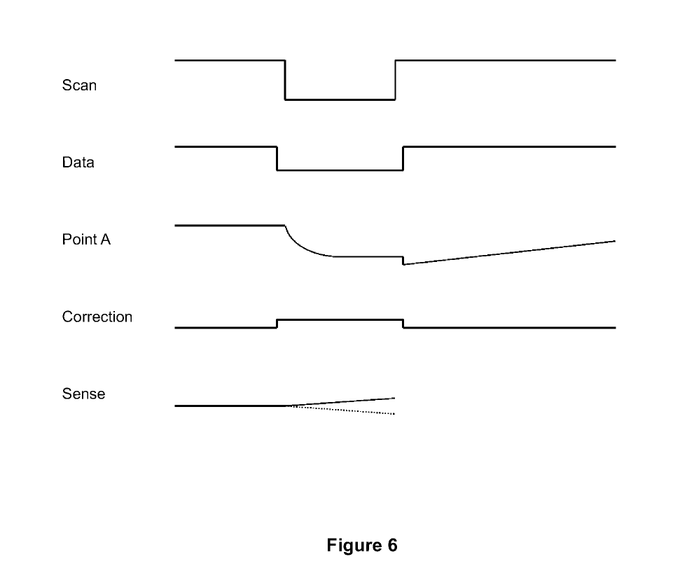

FIG. 6 is a schematic diagram showing a voltage application in a sub-pixel circuit of FIG. 5 as time passes. “Point A” of FIG. 6 corresponds to “Point A” in a wire connected to a gate of the drive TFT 21 of FIG. 5, showing a gate voltage of the drive TFT 21 as time passes.

In FIG. 5(a), a source S4 of the drive TFT 21 is connected to the earth line 71, and a drain D4 is connected to an anode of the OLED 11. A cathode of the OLED 11 is connected to the power line 61. A gate of the drive TFT 21 is connected to one electrode of the capacitive element 52 and a source S6 of the selection TFT 31. A gate of the selection TFT 31 is connected to the scan line 81 and a drain D6 is connected to the data line 91. Meanwhile, the other electrode of the capacitive element 52 is connected to the correction line 111. The gate of the sense TFT 41 is connected to the scan line 81, a source S5 is connected to the sense line 101, and a drain D5 is connected to an anode of the OLED 11.

When a voltage is applied to the scan line 81 and to the gate of the selection TFT 31, the selection TFT 31 becomes activated, causing a data signal (voltage) applied to the data line 91 to be applied to the gate (point A) of the drive TFT 21. This results in a predetermined level of current flowing to the OLED 11, causing the OLED 11 to emit light with luminescence corresponding to the data signal (voltage). When no voltage is present in the scan line 81, the selection TFT 31 becomes deactivated, but the gate voltage (point A) of the drive TFT 21 is maintained at a constant level by the capacitive element 52 until a scan voltage is applied again.

A voltage of the sense line 101 is pre-charged at a level corresponding to an anode voltage that occurs when a predetermined level of current flows through the OLED 11. When a voltage is applied to the scan line 81 and to the gate of the selection TFT 31 and the sense TFT 41, a voltage is applied to a gate of the drive TFT 21, causing a predetermined level of current corresponding to the data signal (voltage) to begin to flow through the OLED 11. At this time, the sense TFT 41 is in the activated state, resulting in a comparison between anode voltage of the OLED 11 and voltage of the pre-charged sense line 101. If the anode voltage is higher than the voltage of the sense line 101, a current flows into the sense line 100. If lower, a current flows out of the sense line 100. A determination as to which one of these two states occurs will be made by the detection of a voltage variation in the sense line 100.

In FIG. 5(b), a source S4 of the drive TFT 21 is connected to the earth line 71, and a drain D4 is connected to an anode of the OLED 11. A cathode of the OLED 11 is connected to the power line 61. A gate of the drive TFT 21 is connected to one electrode of the capacitive element 53 and a source S6 of the selection TFT 31. A gate of the selection TFT 31 is connected to the scan line 81 and a drain D6 is connected to the data line 91. The other electrode of the capacitive element 53 is connected to the anode of the OLED 11. Meanwhile, one electrode of the capacitive element 52 is connected to the anode of the OLED 11, and the other electrode is connected to the correction line 111. An electrode of the sense TFT 41 is connected to the scan line 81, a source S5 is connected to the sense line 101, and a drain D5 is connected to an anode of the OLED 11.

When a voltage is applied to the scan line 81 and to the gate of the selection TFT 31, the selection TFT 31 becomes activated, causing a data signal (voltage) applied to the data line 91 to be applied to the gate (point A) of the drive TFT 21. This results in a predetermined level of current flowing to the OLED 11, causing the OLED 11 to emit light with luminescence corresponding to the data signal (voltage). When no voltage is present in the scan line 81, the selection TFT 31 becomes deactivated, but the gate voltage (point A) of the drive TFT 21 is maintained at a constant level by the capacitive elements 52, 53 until a scan voltage is applied again. The difference from the embodiment of FIG. 5(a) includes the use of the two capacitive elements 52, 53. In other words, the difference is that, when a predetermined level of current begins to flow through the OLED 11, a voltage is applied to the anode of the OLED 11, which causes the capacitive element 53 to act to maintain a voltage between the gate and drain (anode of the OLED 11) of the drive TFT 21, thereby automatically correcting a variation in threshold of the drive TFT 21.

As is the case with the embodiment of FIG. 5(a), the voltage of the sense line 101 is pre-charged at a level corresponding to an anode voltage that occurs when a predetermined level of current flows through the OLED. When a voltage is applied to the scan line 81 and to the gate of the selection TFT 21 and the sense TFT 41, a voltage is applied to a gate of the drive TFT 21, causing a predetermined level of current corresponding to the data signal (voltage) to begin to flow through the OLED. At this time, the sense TFT 10 is in the activated state, resulting in a comparison between the anode voltage of the OLED 11 and voltage of the pre-charged sense line 101. If the anode voltage is higher than the voltage of the sense line 101, a current flows into the sense line 101. If lower, a current flows out of the sense line 101. A determination as to which one of these two states occurs will be made by the detection of a voltage variation in the sense line 101.

Degradation in emission intensity of the OLED 11 caused by to its deterioration usually results in increased resistance which tends to cause a voltage required for passing a predetermined level of current through the OLED 11 to become high. For this reason, the OLED 11, if deteriorated, tends to cause the anode voltage of the OLED 11 to become higher than the pre-charge voltage of the sense line 101. If this occurs, a desired level of emission intensity cannot be obtained even if a predetermined level of current is passed through the OLED 11 (namely, degradation in emission intensity).

The second embodiment (FIGS. 5(a) and (b)) provides means for correcting degradation in emission intensity by applying a correction voltage to the correction line. As shown in FIG. 6, application of the correction voltage following the completion of the scan voltage application increases the gate voltage (point A) of the drive TFT 21 by a degree of the correction voltage, which causes a level of current flowing through the OLED 11 to be increased by a degree corresponding to the correction voltage. The correction voltage is set according to the degree of deterioration of the OLED 11, thereby allowing a predetermined level of emission intensity to be maintained despite the deterioration of the OLED 11.

### Third Embodiment

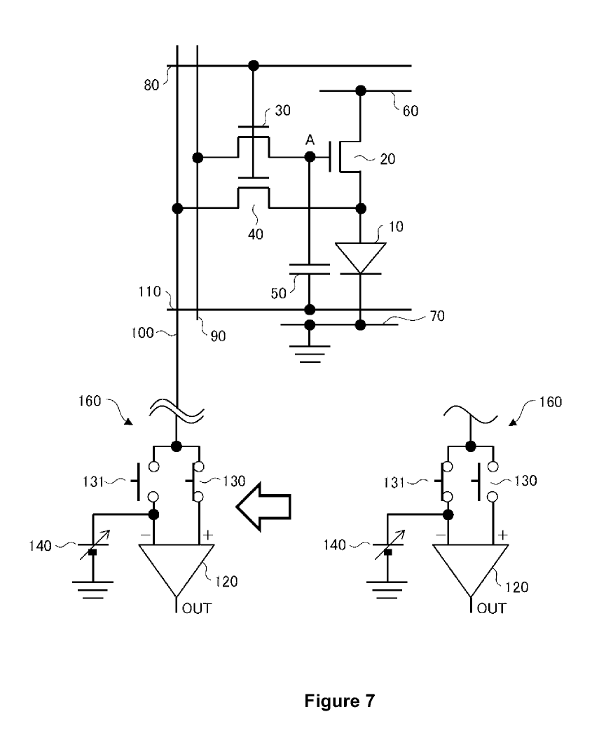

FIG. 7 is a diagram showing a sensing section 160 connected to the sense line 100 of the above mentioned sub-pixel circuit. The sub-pixel circuit shown in FIG. 7 is the same as the circuit shown in FIG. 3, except for the sensing section. For this reason, the same components have the same numerals and symbols in these figures, and repeated descriptions of the same components are omitted.

In the sub-pixel circuit shown in FIG. 7, a voltage set by a pre-charge power supply 140 is applied in advance to the sense line 100 and one terminal (inverted terminal of FIG. 7) of a comparator 120 (pre-charged state), in order to measure an anode voltage of the OLED 10. Such a pre-charged state is shown at the lower right of FIG. 7 where a switch 131 is on and a switch 130 is off and the voltage set by the pre-charge power supply 140 is applied to the inverted terminal of the comparator 120.

Next, when the application of a voltage to the scan line 100 brings the selection TFT 20 and the sense TFT 40 into an activated state, the sense line 100 and the anode of the OLED 10 are electrically connected. At this time, the switch 130 is on and the switch 131 is off, as shown at the lower left of FIG. 7. If the anode voltage of the OLED 10 is lower than the pre-charge voltage, the potential of the sense line 100 goes down slightly, causing a low voltage to be output from the comparator 120 through the process of a comparison in potential between both terminals of the comparator 120. On the contrary, if the anode voltage of the OLED 10 is higher than the pre-charge voltage, the potential of the sense line 100 goes up slightly, causing a high voltage to be output from the comparator 120 through the process of a comparison in potential between both terminals of the comparator 120.

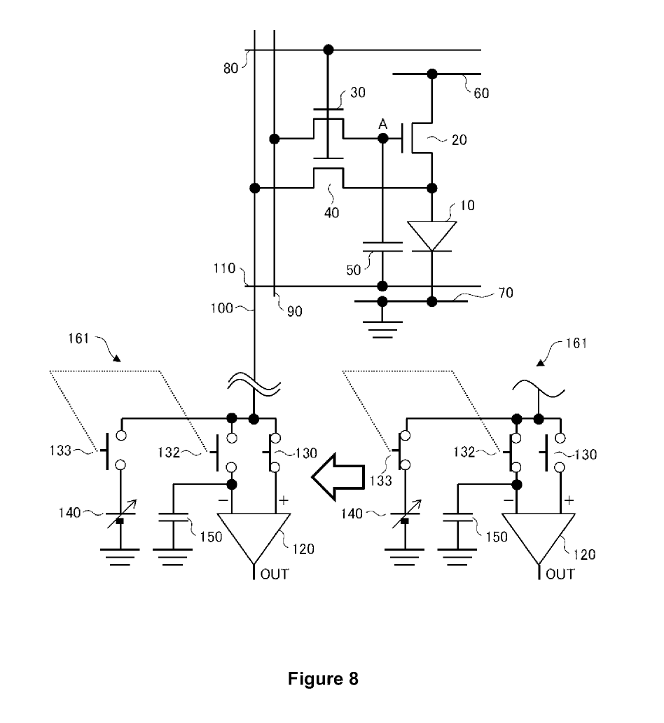

FIG. 8 is a diagram showing a configuration of a sensing section 161 that is different from that of FIG. 7. The sensing section 161 is the same as that of FIG. 7 in that the switch 130 is connected to the non-inverted terminal of the comparator 120, but is different from that of FIG. 7 in that a capacitive element 150 and a switch 132 as well as the pre-charge power supply 140 and a switch 133 are connected to the inverted terminal. The switch 132 and the switch 133 are configured to work together. Other configurations are the same as those of FIG. 7. For this reason, the same components have the same numerals and symbols, and repeated descriptions of the same components are omitted.

In the sensing section 161 having these configurations, when pre-charging takes place, the switch 130 becomes off and the switches 132, 133 become on, causing a voltage set by the pre-charge power supply 140 to be connected to the inverted terminal of the comparator 120, as shown in the lower right of FIG. 8. This results in such a pre-charge voltage being maintained by the capacitive element 150.

When sensing takes place, the sensing section 161 is switched to a state indicated in the lower left of FIG. 8. In other words, both of the switches 132, 133 are off and the switch 130 is on. In conjunction with this, a voltage is applied to the scan line 80, causing the selection TFT 30 and the sense TFT 40 to become on. This results in a voltage applied to the data line 90 being applied to the anode of the OLED 10 through the drive TFT 20. At that time, the sense TFT 40 is on and the sense line 100 is charged at a pre-charge voltage set by the pre-charge power supply 140, causing the anode voltage of the OLED 10 to be input to the non-inverted terminal of the comparator 120 through the sense line 100 for comparison with the pre-charge voltage. If the anode voltage of the OLED 10 is higher than the pre-charge voltage, a high level voltage signal is output from the comparator 120, thereby causing detection of a rise of the anode voltage of the OLED 10.

As described above, the sensing section 161 may have a configuration shown in FIG. 8. In addition, the sensing sections 160, 161 are not limited to these embodiments, and may have other configurations so long as they are capable of detecting a variation in anode voltage of the OLED 10.

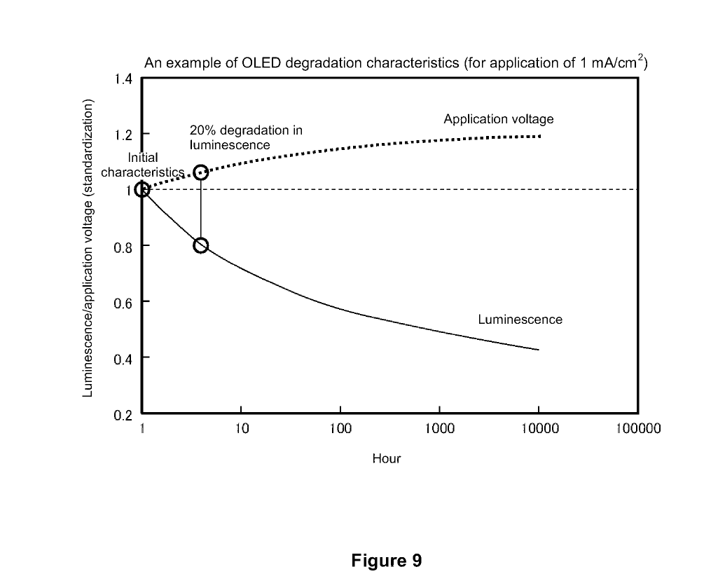

FIG. 9 is a graph showing an example of OLED 10 degradation characteristics. The OLED 10 typically has degradation characteristics shown in FIG. 9. In other words, the OLED 10 suffers from degradation in luminescence with an increase in application voltage as time passes during constant-current operation (at 1 mA/cm²). In a sub-pixel circuit according to the third embodiment, luminescence correction is performed by the measurement of such an increase in application voltage. Even if degradation in the OLED 10 results in an increase in application voltage, the luminescence can be maintained at a constant level by making corrections to increase the application voltage corresponding to such an increase.

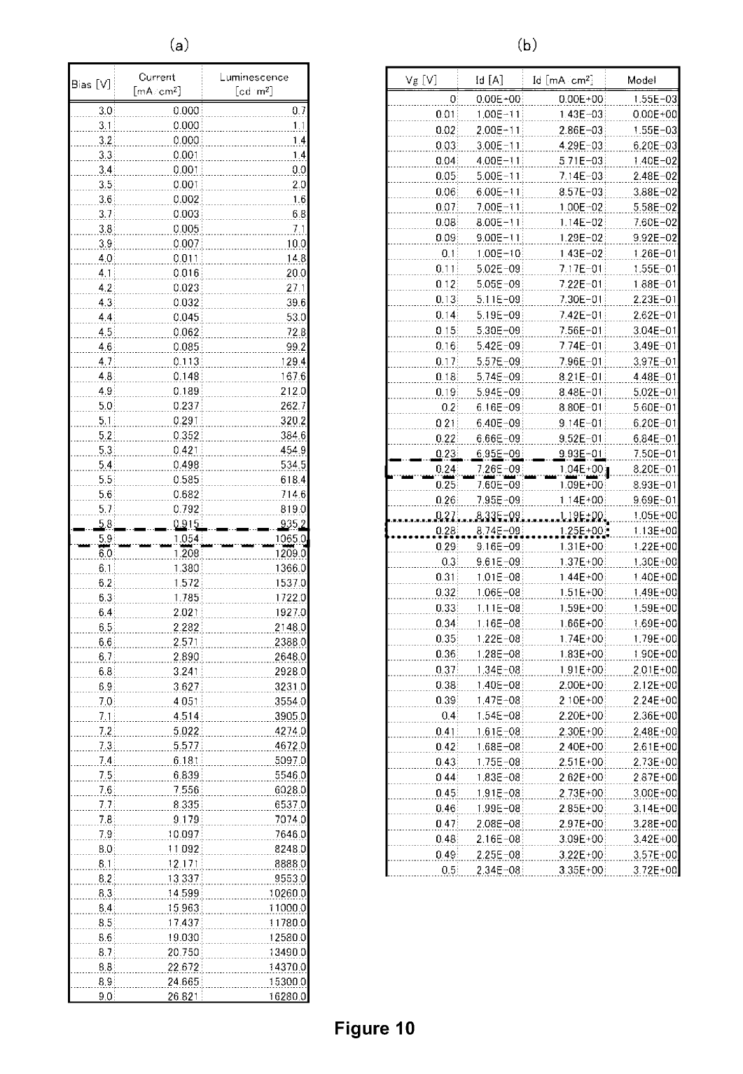

FIG. 10 is an example of a look-up table showing OLED application voltage versus luminescence characteristics and drive TFT application voltage versus drive current characteristics. The OLED 10, for example, has application voltage versus luminescence characteristics shown in FIG. 10(a).

In addition, the drive TFT 20 has gate voltage (Vg) versus drain current (Ig) characteristics (for a constant drain voltage) shown in FIG. 10(b).

For example, in order to operate the OLED 10 at a drive current of about 1 mA/cm² with luminescence of about 1000 cd/m², pre-charging is carried out with anode voltage corresponding to 1,000 cd/m² set to 5.90 V and a pre-charge voltage set to 5.90 V, referencing FIG. 10(b). For the drive TFT 20, a gate voltage is set to 0.24 V to supply a drive current of about 1 mA/cm², referencing FIG. 10(b). If a high signal is output from the comparator 120 at the first scanning, the pre-charge voltage is lower than the anode voltage of the OLED 10, although about 1 mA/cm² flows through the OLED 10. Accordingly, the pre-charge voltage is increased by one step (+0.02 V in this case) for the second scanning. If the output from the comparator 120 becomes low for the first time after these repeated operations (or after 18 repeated operations in this case), the OLED 10 is projected to have an increase in anode voltage of about 6% with a decrease in luminescence of about 20% (from FIG. 9).

As described above, if a variation in anode voltage of the OLED 10 detected via the sense line 100 is in the positive direction (or on the upward trend), the pre-charge voltage may be likewise changed by one step in the positive direction (on the upward trend), thereby detecting the variation in anode voltage of the OLED 10 using the sense line 100 again. The number of steps required for voltage correction can be determined by repeating the above operation until the voltage variation is inverted in the negative direction (or on the downward trend), thereby allowing luminescence correction (or luminous intensity correction) based on proper voltage corrections. Although a voltage variation in the positive direction or on the upward trend is described in this example, the same operation can also be performed for cases where a voltage variation is in the negative direction or on the downward trend. In other words, the pre-charge voltage is changed by the proper number of steps in the negative direction corresponding to the voltage variation of the OLED 10, thereby allowing luminescence correction (or luminous intensity correction) based on proper voltage corrections.

There are two methods for compensating for the decrease in luminescence. One of the methods can be accomplished by changing gate voltage settings of the drive TFT from 0.24 V to 0.28 V. As shown in FIG. 10(b), changing the gate voltage to 0.28 V increases the current Id to be supplied to the OLED 10 by about 20%. This can be accomplished by updating the look-up table of FIG. 10(b). The second method can be accomplished by applying +0.4 V to the correction line 110 following pixel scanning to increase the gate voltage of the drive TFT 20 through the capacitive element 50. In this case, the look-up table for the drive TFT 20 does not need to be updated.

The look-up table may be stored in a predetermined storage element, such as nonvolatile memory or ROM (read only memory). Data, pre-charge voltages, or correction voltages corresponding to a predetermined luminescence may be determined by referencing the look-up table stored in such a storage element.

Also, there is a method for mathematically calculating application voltages without using the look-up table. FIG. 10(b) shows an example of values obtained using mathematical models. Such mathematical models allow a mathematical calculation of a predetermined application voltage. The mathematical models can be stored in a predetermined storage element, such as ROM or RAM. Data, pre-charge voltages, or correction voltages corresponding to a predetermined luminescence may be calculated by referencing the mathematical models stored in such a storage element.

A light-emitting display panel sub-pixel circuit and its drive method described in the embodiments 1 through 3 can be applied to a display panel and display unit employing such a sub-pixel circuit and its drive method. A light-emitting display panel can be configured by arranging in matrix a plurality of pixels each having a light-emitting display panel sub-pixel circuit. In addition, a light-emitting display unit or light-emitting display system can be configured using an image processing circuit, a control circuit, and an enclosure.

Typical configurations of the present invention are described with reference to, but not limited to, the foregoing preferred embodiments. Various modifications are conceivable within the scope of the present invention.

### CITATION LIST

### Patent Literature

PTL 1: Japanese Patent No. 3743387

PTL 2: Japanese Patent No. 4240059

PTL 3: Japanese Patent No. 3613253

### Non Patent Literature

NPL 1: IDW 2001, Proceedings page 315

### PARTS LIST

10, 11 OLED
20, 21 Drive TFT
30, 31 Selection TFT
40, 41 Sense TFT
50-53, 150 Capacitive elements (capacitor)
60, 61 Power line
70, 71 Earth line
80, 81 Scan line
90, 91 Data line
100, 101 Sense line
110, 111 Correction line
120 Comparator
130-133 Switch
140 Pre-charge power source
160, 161 Sensing section

1.-28. (canceled)

29. A light-emitting display panel sub-pixel circuit, comprising:
a power line and an earth line;
at least one light-emitting element connected in series with a drive transistor between the power line and the earth line;
a data line for applying a data voltage, indicative of data, to a control electrode of the drive transistor so as to selectively operate the drive transistor and draw current through the light-emitting element to cause light transmission;
a sense line for detecting voltage variation across the light-emitting element caused by degradation in the light-emitting element;
at least one capacitive element connected to the control electrode of the drive transistor to apply a correcting voltage to the control electrode to compensate for the degradation; and
a scan line for selecting a sub-pixel for light emission;
wherein the data corresponding to a predetermined luminous intensity are programmed on the basis of a voltage.

30. The light-emitting display panel sub-pixel circuit according to claim 29, wherein the power line further includes a correction line.

31. The light-emitting display panel sub-pixel circuit according to claim 30, further comprising
a selection transistor for selecting a sub-pixel for light emission, and
a sense transistor for detecting degradation in the light-emitting element;
wherein an anode of the light-emitting element is connected to a first main electrode of the drive transistor and the sense transistor;
wherein a second main electrode of the sense transistor is connected to the sense line;
wherein a first main electrode of the selection transistor is connected to the data line and a second main electrode is connected to a control electrode of the drive transistor; and
wherein a control electrode of the selection transistor and the sense transistor are connected to the scan line.

32. The light-emitting display panel sub-pixel circuit according to claim 31, wherein the control electrode of the drive transistor and the second main electrode of the selection transistor are connected to the correction line through the at least one capacitive element.

33. The light-emitting display panel sub-pixel circuit according to claim 32,
wherein each of the drive transistor, the selection transistor, and the sense transistor is an n-channel field effect transistor;
wherein the first main electrode is a source electrode;
wherein the second main electrode is a drain electrode; and
wherein the control electrode is a gate electrode.

34. The light-emitting display panel sub-pixel circuit according to claim 31, wherein each of the drive transistor, the selection transistor, and the sense transistor is a field effect transistor which includes an active layer composed mainly of a silicon, metallic oxide, or organic matter.

35. The light-emitting display panel sub-pixel circuit according to claim 31 wherein each of the drive transistor, the selection transistor, and the sense transistor is an n-channel field effect transistor.

36. The light-emitting display panel sub-pixel circuit according to claim 31, wherein each of the drive transistor, the selection transistor, and the sense transistor is a p-channel field effect transistor.

37. The light-emitting display panel sub-pixel circuit according to claim 30, wherein a cathode of the light-emitting element is grounded and a drain electrode of the drive transistor is connected to the power line.

38. The light-emitting display panel sub-pixel circuit according to claim 37, wherein the correction line is grounded.

39. The light-emitting display panel sub-pixel circuit according to claim 37,
wherein a gate electrode of the drive transistor and a drain electrode of the selection transistor are connected to the correction line through first and second capacitive elements;
wherein the first capacitive element is connected between the correction line and the source electrode of the sense transistor; and
wherein the second capacitive element is connected between a gate electrode of the drive transistor and a drain electrode of the selection transistor and a source electrode of the sense transistor.

40. The light-emitting display panel sub-pixel circuit according to claim 35,
wherein each of the drive transistor, the selection transistor, and the sense transistor is a p-channel field effect transistor;
wherein the first main electrode is a drain electrode;
wherein the second main electrode is a source electrode; and
wherein the control electrode is a gate electrode.

41. The light-emitting display panel sub-pixel circuit according to claim 40, wherein a cathode of the light-emitting element is connected to the power line, and a source electrode of the drive transistor is grounded.

42. The light-emitting display panel sub-pixel circuit according to claim 40, wherein a gate electrode of the drive transistor and a source electrode of the selection transistor are connected the correction line through first and second capacitive elements;
wherein the first capacitive element is connected between the correction line and the drain electrode of the sense transistor; and
wherein the second capacitive element is connected between a gate electrode of the drive transistor and a source electrode of the selection transistor and a drain electrode of the sense transistor.

43. A method for driving a light-emitting display panel sub-pixel comprising the light-emitting display panel sub-pixel circuit according to claim 31, comprising:
pre-charging the sense line of the light-emitting display panel sub-pixel circuit at a predetermined pre-charge voltage; and
detecting a voltage variation in the sense line which occurs when the sense transistor becomes on at the time of a sub-pixel selection.

44. The method according to claim 43, wherein, if the voltage variation in the sense line is found to be in a positive or negative direction, changing the pre-charge voltage by one predetermined step in the same direction as the positive or negative direction, and detecting the voltage variation again.

45. The method according to claim 44, further comprising repeating the changing and detecting steps until the detected voltage variation is inverted in the direction opposite the positive or negative direction.

46. The method according to claim 43, wherein luminous intensity of the light-emitting element is corrected by applying a correction voltage to the correction line.

47. The method according to claim 43, wherein luminous intensity of the light-emitting element is corrected by additionally applying a correction voltage to a gate electrode of the drive TFT.

48. The method according to claim 46, wherein the correction voltage is set on the basis of a step width corresponding to the voltage variation in the sense line.
